(19) United States
(12) Patent Application Publication
(10) Pub. No.: US 2026/0029992 A1
(43) Pub. Date: Jan. 29, 2026

(54) MODULAR REDUCTION OPERATION METHODS AND APPARATUSES

(71) Applicant: ANT GROUP CO., LTD., Hangzhou (CN)

(72) Inventors: Jiming XU, Hangzhou (CN); Yilan ZHU, Hangzhou (CN); Zhongmiao SU, Hangzhou (CN); Shaohua DU, Hangzhou (CN); Peng WU, Hangzhou (CN)

(21) Appl. No.: 19/283,032

(22) Filed: Jul. 28, 2025

(30) Foreign Application Priority Data
Jul. 29, 2024 (CN) 202411026190.4

(51) Int. Cl. G06F 7/72

(52) U.S. Cl. CPC G06F 7/72

(57) ABSTRACT

Embodiments of this specification provide modular reduction operation methods and apparatuses. In a service processing process based on secure computation, a modulo operation is performed on a given value x for a related modulus (prime number). In a related multiplication operation, processing such as shifting and addition can be performed on another multiplier based on redundant bits in one multiplier, and only consecutive non-overlapping bits in the one multiplier are used as significant bits to implement the multiplication operation with the another multiplier by using a DSP unit. This greatly reduces online usage of DSP units, and improves modular reduction efficiency.

### TECHNICAL FIELD

One or more embodiments of this specification relate to the field of secure computation technologies, and in particular, to modular reduction operation methods and apparatuses in secure computation.

### BACKGROUND

A privacy protection-related operation includes privacy-preserving computation technologies such as homomorphic encryption, secret sharing, and post-quantum cryptography. A modular reduction algorithm is often used in privacy-preserving computation. Computational performance of privacy-preserving computation degrades (for example, degrades by 4 or 5 orders of magnitude) compared with that of plaintext computation. Therefore, to enable fully homomorphic encryption to be used in an actual scenario, proper hardware needs to be used to accelerate an algorithm and an application of fully homomorphic encryption.

Fully homomorphic encryption is used as an example. Homomorphic operations of fully homomorphic encryption can include homomorphic addition, homomorphic multiplication, rescaling, relinearization, and rotation. Various homomorphic applications can be implemented by combining these homomorphic operations, including homomorphic matrix multiplication, a homomorphic neural network, etc. The homomorphic operation also includes a basic operation performed on a polynomial in ciphertext at a lower level. The basic operation includes modular multiplication, modular addition, modular subtraction, automorphism, number-theoretic transform (NTT), and inverse number-theoretic transform (INTT).

Optimizing an underlying basic operation can have a more significant acceleration effect on the homomorphic operation and the homomorphic application. A modular operation is an underlying operation in a homomorphic encryption operation, and a modular reduction operation is widely used in operations such as modular multiplication and NTT/INTT. Modular reduction is an operation commonly used in the modular operation, and is used to compute a remainder when a large integer is divided by a modulus. The purpose of modular reduction is to constrain a result within a specific range, which is typically a non-negative integer range, generally achieved through polynomial long division. Conventional modular reduction algorithms include, for example, Montgomery modular reduction and Barrett modular reduction.

It can be understood that the essence of computer computation is implemented by a hardware circuit. For example, the modular reduction algorithm relates to use of resources such as DSP (digital signal processing), a LUT (look-up table), and an FF (Flip Flop, trigger). Barrett modular reduction is used as an example. Two multiplication operations (modular multiplication or mtiply-then-mod) are needed. The two multiplication operations need DSP resources, and other operations may need only LUT and FF resources. A DSP unit is a specific hardware unit in an FPGA that is specifically used for high-performance digital signal processing, and generally includes a multiplier, an accumulator, and another digital signal processing-related function. A quantity of DSP units used in single multiplication computation is related to a quantity of data bits computed. For example, for a DSP unit that supports multiplication of a 27×18 bit width, six DSP units need to be used to compute multiplication of multiplying a 54-bit value by a 54-bit value. During cipher computation (for example, a homomorphic encryption operation), a large quantity of modular reduction operations may be performed. Optimizing DSP resources used in the modular reduction operation can improve service processing efficiency of secure computation based on fully homomorphic encryption, post-quantum cryptography, etc.

### SUMMARY

One or more embodiments of this specification describe modular reduction operation methods and apparatuses, to resolve one or more problems mentioned in the background.

According to a first aspect, a modular reduction operation method is provided, and is used to perform a modulo operation on a first modulus for a given value x in secure computation. The method includes: obtaining a modular reduction factor r₁ corresponding to the first modulus; detecting at least one group of significant bits in the modular reduction factor r₁, where the significant bits are a plurality of consecutive bits that include non-overlapping bits, and the non-overlapping bits are adjacent different bits; computing a first product of each group of significant bits and the given value x; sequentially merging the first product with second products, and shifting a merging result to the right by a first quantity of bits to obtain a first reference factor, where a single second product is determined by performing a corresponding bit operation on the given value x based on a corresponding single group of redundant bits, and the single group of redundant bits include a plurality of consecutive overlapping bits; subtracting a third product of the first reference factor and the first modulus from the given value x, to obtain a second reference factor; and comparing the second reference factor with the first modulus to determine a modular reduction result of the given value x for the first modulus based on a comparison result.

In an embodiment, the modular reduction factor r₁ is obtained by taking the floor of a quotient of 2 to the power of 2k divided by the first modulus, and a predetermined value k meets a first condition: 2 to the power of k is greater than the first modulus.

In an embodiment, the computing a first product of each group of significant bits and the given value x is implemented by invoking a DSP unit.

In an embodiment, the sequentially merging the first product with second products includes: separately determining bit positions of the first product and the second product relative to the modular reduction factor r₁; and splicing and adding the first product and the second product based on the bit positions, to obtain a merging result.

In an embodiment, the first quantity is 2k.

In an embodiment, when the single group of redundant bits are s consecutive 1s, the corresponding single second product is determined by performing a bit operation: shifting the given value x to the left by s+1 bits in a binary representation way and subtracting the given value x after padding vacated bits with 0s; when the single group of redundant bits are s consecutive 0s, the corresponding single second product is determined by performing a bit operation: setting each bit to 0; and when the single group of redundant bits include 1 of a d^{th} bit and several 0s, the corresponding single second product is determined by performing a bit operation: shifting the given value x to the left by d bits.

In an embodiment, the third product is determined in the following way: detecting at least one group of significant bits in the first modulus, and computing a fourth product of each group of significant bits and the given value x; and sequentially merging the fourth product with fifth products, and shifting a merging result to the right by the first quantity of bits in a binary representation way to obtain the third product, where a single fifth product is determined by performing a corresponding bit operation on the first reference factor based on a corresponding single group of redundant bits of the first modulus.

In an embodiment, the comparing the second reference factor with the first modulus to determine a modular reduction result of the given value x for the first modulus based on a comparison result includes: when the second reference factor is less than the first modulus, determining the second reference factor as the modular reduction result; or when the second reference factor is greater than or equal to the first modulus, determining a difference between the second reference factor and the first modulus as the modular reduction result.

According to a second aspect, a modular reduction operation apparatus is provided, and is used to perform a modulo operation on a first modulus for a given value x in secure computation. The apparatus includes:
an acquisition unit, configured to obtain a modular reduction factor r₁ corresponding to the first modulus;
a detection unit, configured to detect at least one group of significant bits in the modular reduction factor r₁, where the significant bits are a plurality of consecutive bits that include non-overlapping bits, and the non-overlapping bits are adjacent different bits;
a first computation unit, configured to: compute a first product of each group of significant bits and the given value x; and
sequentially merge the first product with second products, and shift a merging result to the right by a first quantity of bits to obtain a first reference factor, where a single second product is determined by performing a corresponding bit operation on the given value x based on a corresponding single group of redundant bits, and the single group of redundant bits include a plurality of consecutive overlapping bits;
a second computation unit, configured to subtract a third product of the first reference factor and the first modulus from the given value x, to obtain a second reference factor; and
a determining unit, configured to compare the second reference factor with the first modulus to determine a modular reduction result of the given value x for the first modulus based on a comparison result.

According to a third aspect, a computer-readable storage medium is provided. The computer-readable storage medium stores a computer program, and when the computer program is executed on a computer, the computer is enabled to perform the method according to the first aspect.

According to a fourth aspect, a computing device is provided, including a memory and a processor. The memory stores executable code, and when the processor executes the executable code, the method according to the first aspect is implemented.

According to the method and the apparatus provided in embodiments of this specification, in a service processing process based on secure computation, a modulo operation is performed on a given value x for a related modulus (prime number). In a related multiplication operation, bit processing such as shifting and addition can be performed on another multiplier based on redundant bits in one multiplier, and only consecutive non-overlapping bits in the one multiplier are used as significant bits to implement the multiplication operation with the another multiplier by using a DSP unit. This greatly reduces online usage of DSP units, and improves modular reduction efficiency, thereby improving service processing efficiency of secure computation based on fully homomorphic encryption, post-quantum cryptography, etc.

### BRIEF DESCRIPTION OF DRAWINGS

To describe the technical solutions in embodiments of this specification more clearly, the following briefly describes the accompanying drawings needed for describing the embodiments. Clearly, the accompanying drawings in the following description show merely some embodiments of this specification, and a person of ordinary skill in the art can derive other drawings from these accompanying drawings without creative efforts.

FIG. 1 is a schematic diagram illustrating an modulus in a specific implementation scenario;

FIG. 2 is a schematic flowchart illustrating a modular reduction operation, according to an embodiment; and

FIG. 3 is a schematic block diagram illustrating a modular reduction operation apparatus, according to an embodiment.

### DESCRIPTION OF EMBODIMENTS

The following describes the technical solutions provided in this specification with reference to the accompanying drawings.

Embodiments of this specification are used to optimize computing resources based on a Barrett modular reduction algorithm. First, a Barrett modular reduction principle in a conventional technology is described.

A modulus n is given, where n is a natural number greater than or equal to 3, and n is not a multiple of 2 (for example, n is a prime number). A natural number k is selected, so that 2^{k}>n (that is, a minimum value of k can be a result [log ₂n] of taking the ceiling of log ₂n). Therefore, for the given modulus n, a modular reduction factor

$$r = ⌊ \frac{{4}^{k}}{n} ⌋$$

can be pre-computed. For a given number x (assuming 0≤x<n²), modular reduction of x modulo n is performed, that is, a remainder of x divided by n is computed. In this case,

$$t = x - ⌊ \frac{xr}{{4}^{k}} ⌋ n$$

can be computed online. Generally, a maximum quantity of moduli n included in x can be determined by using two taking the floor operations

$$r = ⌊ \frac{{4}^{k}}{n} ⌋ and ⌊ \frac{xr}{{4}^{k}} ⌋ .$$

However, a critical value may be obtained in a first taking the floor process, so that an integer obtained in a second taking the floor process is not the maximum quantity of moduli included in x. Therefore, values of t and n can be further determined. Specifically, when t<n, t is a modulo result of x modulo n; otherwise, when ten, t-n is a modulo result of x modulo n. For a proving process, refer to a common knowledge record like “https://blog.csdn.net/qq_57502075/article/details/130052118”. Details are omitted here for simplicity.

In the above-mentioned process, two multiplication operations x×r and

$$⌊ \frac{xr}{{4}^{k}} ⌋ \times n$$

are performed in single modular reduction online computation. Here,

$$\frac{xr}{{4}^{k}}$$

can be implemented by cyclically shifting xr to the right by 2k bits. Because one of two multipliers in each of the two multiplication operations is a pre-known number, which are respectively a prime modulus (or referred to as a modulus) n and a pre-computed modular reduction factor r whose values depend on a parameter selected by a given homomorphic application. In homomorphic matrix multiplication, generally, there are 1 or 2 values of the prime modulus n. In a complex service, there may be more, for example, more than 30, values of the prime modulus n. In this case, the prime modulus n can be generated in a predetermined rule mode. For example, in a fully homomorphic encryption operation, a small prime modulus can be generated in the following way: nᵢ=2^{bit_size}−2·poly_size·t+1, where poly_size represents a quantity of terms in a fully homomorphic encryption polynomial, bit_size represents a quantity of bits defined for a coefficient of the polynomial, and t represents a current prime number generation seed. The pre-computed modular reduction factor is:

$${r}_{i}^{′} = \frac{{4}^{k}}{{n}_{i}} .$$

During generation or nᵢ, a value of t starts from 0, and is incremented by 1. Whether a value generated under a single value of t is a prime number is checked until a predetermined quantity of L prime numbers are found. The predetermined quantity L is a quantity of times of performing modular reduction, namely, a quantity of times of performing a multiplication operation. A single multiplication operation includes two multiplication processes. Execution efficiency of fully homomorphic encryption is closely related to a quantity of DSP units used in L times of multiplication. To compute multiplication of multiplying L 54-bit numbers by a 54-bit number, six DSP units need to be used to perform L corresponding multiplication operations.

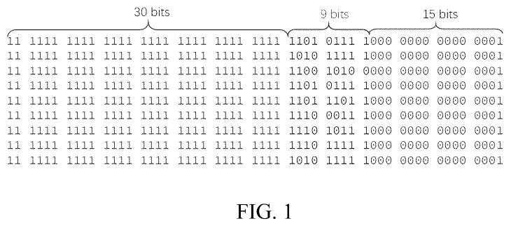

FIG. 1 shows an example of first 10 prime numbers generated under conditions of bit_size=54, and poly_size=2¹⁶. In view of a service need for improving operation efficiency of a multiplication operation, it can be learned by observing multipliers nᵢ and rᵢ′ in an online multiplication operation that, prime numbers generated under a generation mechanism of a prime number nᵢ for fully homomorphic encryption are close to each other, and a binary representation of the prime number n; includes a large quantity of consecutive “0” and “1” bits. As shown in FIG. 1, the most significant 30 bits of the 10 prime numbers are all 1s, and the least significant 15 bits are all 14 0s and the least significant bit 1. That is, a difference between the 10 prime numbers lies in only nine bits in the middle. A modular reduction factor rᵢ′ represents a quantity of prime numbers included in a given value. In actual application, it is found through observation that a binary representation of modular reduction factor rᵢ′ also has a large quantity of consecutive “0” and “1” bits.

A person skilled in the art can understand that splitting a binary form of a number n into a plurality of groups of consecutive bits includes: n=a·2^{y}+b·2^{z}+c, where c can be 0, coefficients a and b are values of a corresponding single group of bits, and 2^{y} and 2^{z} each are a multiple of a difference between the least significant bit of a single group of bits and the least significant bit of a binary representation of n, or y and z each are a quantity of bits by which a binary bit is shifted to the left relative to the least significant bit of n. For example, a binary number m=″11110001″ can be split into a=1111=10000-00001 (where a binary number 10000 is 2⁵), y=4, b=0001, z=0, and c=0. In this way, a product of numbers x and n can be represented as: xn=ax·2^{y}+bx·2^{z}+cx. In other words, in a binary system, the product of x and n can be split into multiplication operations between each of a plurality of groups of bits and x. An operation between a and x is performed by shifting x to the left by a corresponding quantity of bits (for example, five bits) and performing subtraction, and multiplication of b and x is x.

Further, based on a multiplication computation feature in a binary system, at least most significant 30 bits and least significant 15 bits of prime numbers shown in FIG. 1 can be separately split and computed. For example, a value of the most significant 30 bits is 30 consecutive 1s, which can be considered as 2³¹−1. A product of a number x and a number whose 30 bits are all 1s is: x×2³¹−x, that is, shifting a binary representation of x to the left by 31 bits and then subtracting x. The least significant 15 bits include a plurality of consecutive 0s and one 1 (or 14 consecutive 0 bits and one 1 bit), and a product of the number x and the least significant 15 bits is the least significant 15 bits. Products of each of the most significant 30 bits and the least significant 15 bits and another multiplier x each are respectively recorded as second products for 9 bits in the middle, and multiplication computation of each of the most significant 30 bits and the least significant 15 bits and the another multiplier x can be implemented by using a DSP unit, to obtain a corresponding product result. The computation result is recorded as a first product. In this case, the first product can be merged between the two second products in a bit corresponding order, to obtain a multiplication operation result of the value x and the prime number n.

In other words, a plurality of different consecutive bits (consecutive non-overlapping bits) between single prime numbers can be used as significant bits for a multiplication operation, and other same consecutive bits (redundant bits) are split out for an operation through shifting and subtraction. Therefore, a bit width occupied by the multiplication operation can be greatly reduced. For example, a multiplication operation of a 54-bit value shown in FIG. 1 can be converted into a multiplication operation of a 9-bit value. when a DSP unit that supports multiplication of a 27*18 bit width (for example, DSP48E2 used by an FPGA development board of Xilinx) is used, two DSP units can be used to process a 54-bit number multiplied by a 9-bit number, which is less than six DSP units needed to multiply two 54-bit-width numbers. Finally, a Barrett modular reduction process can need only four DSP units instead of original 12 (two multiplication operations, 6×2) DSP units. This can greatly reduce a usage quantity of DSP units.

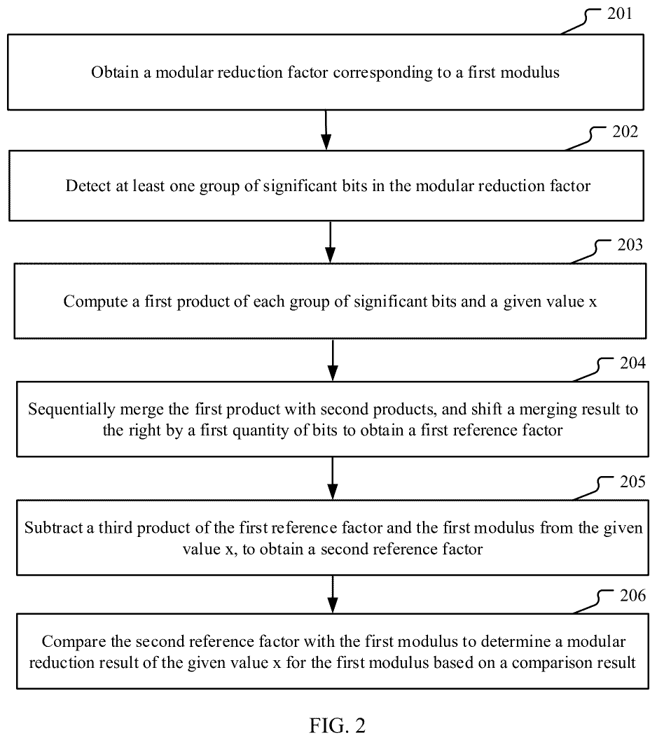

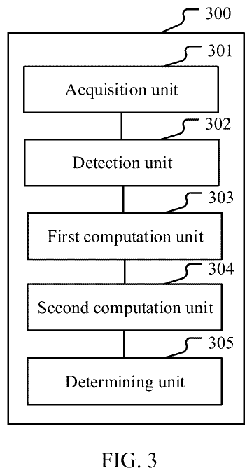

The following describes the technical concept of this specification in detail with reference to the embodiments shown in FIG. 2 and FIG. 3.

FIG. 2 illustrates a modular reduction operation process according to an embodiment. The process can be executed by any computer, device, or server that has a specific computing capability, for example, a single data party in a multi-party secure computation architecture. The process can be a modular reduction process executed online.

As a specific example, the modular reduction process provided in this embodiment of this specification can be used to perform a modulo operation on a given value x by using any one of L moduli (denoted as a first modulus below) in secure computation. The L moduli can be prime numbers generated based on a predetermined rule in secure computation. For example, in fully homomorphic encryption computation, each prime number is generated based on a polynomial size poly_size and a quantity of bits bit_size of a polynomial coefficient. The predetermined rule is, for example, nᵢ=2^{bit_size}−2·poly_size·t+1. During generation of a prime number, t is used as a seed to detect whether a value generated based on the predetermined rule is a prime number; and if yes, the value is reserved; otherwise, the value is discarded. A value of t is changed until a predetermined quantity (not less than L) of prime numbers are generated. In practice, when t continuously changes (for example, increases by 1 in each iteration starting from an initial value), generated prime numbers are close to each other. In prime numbers represented in binary, values of a plurality of bits may be close, and values of a part of bits are different. The prime numbers can be pre-generated, or can be generated online. This is not limited here. The L moduli are a part or all of prime numbers generated under a uniform rule.

As shown in FIG. 2, the modular reduction operation process according to this embodiment can include the following steps: Step 201: Obtain a modular reduction factor r₁ corresponding to a first modulus. Step 202: Detect at least one group of significant bits in the modular reduction factor r₁, where the significant bits are a plurality of consecutive bits that include non-overlapping bits, and the non-overlapping bits are adjacent different bits. Step 203: Compute a first product of each group of significant bits and a given value x. Step 204: Sequentially merge the first product with second products, and shift a merging result to the right by a first quantity of bits to obtain a first reference factor, where a single second product is determined by performing a shifting operation on the given value x based on a corresponding single group of redundant bits, and the single group of redundant bits include a plurality of consecutive consistent bits. Step 205: Subtract a third product of the first reference factor and the first modulus from the given value x, to obtain a second reference factor. Step 206: Compare the second reference factor with the first modulus to determine a modular reduction result of the given value x for the first modulus based on a comparison result.

First, in step 201, the modular reduction factor r₁ corresponding to the first modulus is obtained.

Here, the first modulus can be any modulus used for a modular reduction operation, for example, one of moduli in a fully homomorphic encryption computation process, or more specifically, one of moduli shown in FIG. 1. The first modulus can generally be a prime number, for example, denoted as n₁.

The modular reduction factor is a factor used to determine a multiple relationship between a given value and a current modulus during modular reduction. The modular reduction factor corresponding to the first modulus is, for example, denoted as r₁. Based on a modular reduction principle, a way of determining r₁ is, for example, taking the floor of a ratio of 2^{2k} to the first modulus n, for example, denoted as

$${r}_{1} = ⌊ \frac{{4}^{k}}{n} ⌋ .$$

Here, k is a predetermined natural number, and generally, 2^{k}>n₁. In this way, 2^{2k} can be far greater than n₁, so that the modular reduction factor r₁ can have a non-zero value on a plurality of bits, and a significant difference is generated for different n₁, to adapt to a value x of a wider range. The modular reduction factor r₁ can be computed by using a conventional computation method, for example, invoking a corresponding multiplication operator for computation.

To save computing resources for online service processing and improve computing efficiency, the modular reduction factor r₁ can be pre-computed before a modular reduction operation is performed, or can be computed by using another device. In this way, in step 201, the modular reduction factor r₁ can be directly obtained.

Next, by using step 202, at least one group of significant bits in the modular reduction factor r₁ is detected. The significant bits are a plurality of consecutive bits that include non-overlapping bits, and the non-overlapping bits are adjacent different bits.

Based on the technical concept of this specification, when the modular reduction factor r₁ is used as a multiplier for multiplication computation, bit splitting can be performed on the modular reduction factor r₁. For splitting of the modular reduction factor r₁, refer to the modulus shown in FIG. 1 to be performed based on overlapping bits and consecutive non-overlapping bits. For ease of description, here, the non-overlapping bits can be referred to as significant bits. Specifically, significant bits in the modular reduction factor r₁ can be first detected. Generally, when different values exist on adjacent bits, the adjacent bits can be referred to as non-overlapping bits.

It can be learned from the specific example shown in FIG. 1 that non-overlapping bits and overlapping bits may be interleaved in distribution. Therefore, to better use computing resources, bits in a predetermined length of bits in which non-overlapping bits are concentrated can be determined as a group of consecutive non-overlapping bits, and significant bits can include one or more groups of consecutive non-overlapping bits. Here, a predetermined quantity can be related to a bit width processed by a DSP unit. For example, for a DSP unit that supports a 27*18 bit width, a predetermined length can be 9. As shown in FIG. 1, in the nine bits in the middle of the value represented by the first row, a value of the nine bits includes both 0 and 1, and when a predetermined length is 9, the included bits can also include adjacent same values, for example, a plurality of consecutive Is (consecutive overlapping bits).

It can be understood that, when a modular reduction operation needs to be continuously performed on a plurality of moduli in a current service, based on a modulus generation rule, values of adjacent moduli may be similar, and non-overlapping bits of the moduli are distributed in a centralized way. Therefore, in some embodiments, all of a plurality of (for example, L) moduli can be split into consecutive non-overlapping bits. As shown in FIG. 1, it is detected that non-overlapping bits of the moduli are distributed in the nine bits in the middle in a centralized way shown in the figure. Therefore, the nine bits can be used as a group of consecutive non-overlapping bits.

In addition, other bits separated by the consecutive non-overlapping bits can be used as redundant bits. The redundant bits can include a plurality of consecutive overlapping bits. As shown in FIG. 1, two groups of redundant bits can be first 30 bits and last 15 bits. Similar to the modulus, the reduction factor can also be used to split consecutive non-overlapping bits and redundant bits in the way shown in FIG. 1. When moduli are similar, modular reduction factors determined based on the moduli may also be similar. In this case, all of the modular reduction factors of the moduli can also be used to split consecutive non-overlapping bits and redundant bits.

Then, the first product of each group of significant bits and the given value x is computed by using step 203.

Based on the technical concept of this specification, when the significant bits are used as a multiplier, it is difficult to implement a multiplication operation by using a bit operation like simple shifting or addition. Therefore, a DSP unit can be used to compute a product of significant bits in a first modular reduction factor and the given value x. A single group of significant bits can correspond to a single product, which is referred to as the first product below. When there are a plurality of groups of consecutive non-overlapping bits in the significant bits, a plurality of first products can be obtained. Details are omitted here for simplicity.

Next, in step 204, the first product is merged with the second products, and a merging result is shifted to the right by the first quantity of bits to obtain the first reference factor.

The single second product can be based on a product of the given value x and the single group of redundant bits. It can be understood that the single group of redundant bits can include a plurality of consecutive bits 0s or 1s. For a plurality of consecutive 0s, a product of the plurality of consecutive 0s and the value x is still 0, a product of a single 1 and the value x is 1, a product of h consecutive Is and the value x can be determined by using xx (2^{h+1}−1), and x×2^{h+1} can be implemented by shifting h+1 bits to higher bits. Therefore, when the single group of redundant bits are a plurality of consecutive 0s, the single second product can be a plurality of bits 0s. When the single group of redundant bits are a plurality of consecutive 1s, the single second product can be implemented by using a shifting operation and subtraction. Details are omitted here for simplicity. In an optional embodiment, the single group of redundant bits can further include a plurality of 0s and 1 on a d^{th} bit from low to high bits. In this case, the given value x can be shifted to the left by d bits in a binary representation way to obtain the corresponding single second product. As shown in FIG. 1, a single group of redundant bits corresponding to the last 15 bits include 14 0s on high bits and 1 on a 0^{th} bit (the least significant bit). In this case, the single second product of the single group of redundant bits and the value x is a binary representation of x (shifting to the left by 0 bits).

Generally, a quantity of binary bits of the single second product that is of the group of redundant bits and the value x and that is obtained by performing an operation like shifting can be less than the group of redundant bits, equal to the group of redundant bits, or greater than the group of redundant bits. Similarly, a quantity of bits of the first product may also be less than, equal to, or greater than a corresponding group of consecutive non-overlapping bits. When both the first product and the second product are less than a corresponding group of redundant bits or a corresponding group of consecutive non-overlapping bits, the first products and the second products can be merged in a splicing way in an order of the corresponding group of redundant bits or the corresponding group of consecutive non-overlapping bits. When a quantity of bits in the first product and the second product exceeds a product of the corresponding group of redundant bits or the corresponding group of consecutive non-overlapping bits, bit positions corresponding to the first product and the second product relative to the modular reduction factor can be first determined, and then the first products and the second products are added based on corresponding bits. Optionally, bit padding can be further performed on the first product and the second product, that is, 0 is padded to a lower bit based on positions of the corresponding group of redundant bits or the corresponding group of consecutive non-overlapping bits in the modular reduction factor. In this way, when r₁=a·2^{y}+b·2^{z}+, multiplication of a corresponding term and coefficients 2^{y} and 2^{z} in xr₁=ax·2^{y}+bx·2^{z}+x is implemented through shifting.

For example, x=68, a binary form is 1000100, and r₁ is a value in the first row in FIG. 1, and includes 30 redundant bits whose bit values are 1 (for example, a first group of redundant bits), 9 significant bits (11010111, for example, a group of consecutive non-overlapping bits), 14 redundant bits whose bit values are 0, and one bit whose bit value is 1 (for example, a second group of redundant bits). In this case, a product of x and r₁ includes: a second product of the first group of redundant bits and x; a first product of continuous non-overlapping bits and x; and a second product of the second group of redundant bits and x. The single second product of the first group of redundant bits and x is determined by shifting x to the left by 31 bits and subtracting x, for example, 1000100 00 0000 0000 0000 0000 0000 0000 0000−1000100=1000011 11 1111 1111 1111 1111 1111 1101 1100 (greater than 30 bits), the first product of the continuous non-overlapping bits 11010111 (a decimal number 215) and x is 11 1001 0001 1100 (greater than 9 bits), and the single second product of the second group of redundant bits and x is x (000 0000 0100 0100). During merging, bit alignment is considered. In a specific example, the most significant five bits “11 100” of the second product and the least significant five bits “1 1100” of the single second product of the first group of redundant bits and x can be aligned and added (to obtain, for example, 1000011 11 1111 1111 1111 1111 1111 1111 1000 1 0001 1100), and then spliced with the single second product 000 0000 0100 0100 of the second group of redundant bits and x, and a merging result is, for example, 1000011 11 1111 1111 1111 1111 1111 1111 1000 1 0001 1100 000 0000 0100 0100. In another specific example, 15+9=24 0s can be padded after the single second product of the first group of redundant bits and x, and 15 0s are padded after the first product, and then the first product and the single second product of the second group of redundant bits and x are added to obtain a merging result.

A merging result of the first product and the second product is a product of x and r₁. Further, based on the modular reduction principle, an operation of shifting to the right by the first quantity (for example, 2k) of bits can be performed on the merging result, and overflowed bits are discarded, to implement a taking the floor operation on

$$\frac{{xr}_{1}}{{4}^{k}} ,$$

and obtain the first reference factor

$${r}_{11} = ⌊ \frac{{xr}_{1}}{{4}^{k}} ⌋ .$$

In the above-mentioned example, it is assumed that k=55. In this case, the last 55*2 bits, namely, 0s, are discarded. This is because x is far less than n₁, and a quantity of integers n₁ included in x is 0. Generally, when x>n₁, a first reference factor greater than 0 can be obtained.

In a possible design, the first products and the second products can be first shifted to the right by 2k bits, and then merged together. Before shifting to the right is performed, a coefficient when splitting is performed needs to be considered, and a corresponding quantity of bits 0s need to be padded to lower bits. Details are omitted here for simplicity.

In conclusion, during computation of xr₁, only multiplication of x and a group of consecutive non-overlapping bits (for example, nine bits) is computed, which is far less than a quantity of bits (for example, 54) of the modular reduction factor, so that online usage of DSP units can be reduced.

Further, based on step 205, the second reference factor is obtained by subtract the third product of the first reference factor and the first modulus from the given value x.

It can be understood that a large quantity of redundant bits exist in a modular reduction factor corresponding to a modulus generally selected for fully homomorphic encryption, and are related to a large quantity of redundant bits exist in the first modulus. In a process of determining the third product of the first reference factor and the first modulus, the first modulus can be predetermined data, and the first reference factor is data determined in a current procedure (for example, in step 204). When a large quantity of redundant bits exist in the first modulus, the first modulus can be grouped into several consecutive non-overlapping bits and redundant bits. For the redundant bits in the first modulus, a corresponding product of the redundant bits and the first reference factor can be determined by using shifting, addition, etc. For the consecutive non-overlapping bits in the first modulus, a corresponding product of the consecutive non-overlapping bits and the first reference factor can be computed by using a DSP unit. Then, products of all parts are merged. In a possible design, the process of computing the third product of the first reference factor r₁₁ and the first modulus n₁ is similar to the process of computing the product of x and r₁ in the above-mentioned specification, and details are omitted here for simplicity. In this way, DSP resource consumption can be greatly reduced.

Based on the modular reduction principle, the second reference factor (for example, denoted as r₁₂) can be obtained by subtracting the third product from the given value x, which is equivalent to subtracting an integer quantity of n₁. It can be learned from the above-mentioned description that the first reference factor can be used to describe a quantity of first moduli n₁ included in the given value x. However, because two taking the floor operations are performed, the quantity of n₁ may be underestimated (underestimated by one at most). Therefore, the third product can be subtracted from the given value x to obtain a reference value rather than a modular reduction result.

Then, by using step 206, the second reference factor is compared with the first modulus to determine the modular reduction result of the given value x for the first modulus based on the comparison result.

As described above, the second reference factor r₁₂ can be compared with the first modulus n₁ to determine the modular reduction result of the given value x for the first modulus based on the comparison result.

Specifically, when the second reference factor is less than the first modulus, the second reference factor r₁₂ can be determined as the modular reduction result; or when the second reference factor is greater than or equal to the first modulus, a difference between the second reference factor r₁₂ and the first modulus n₁ can be determined as the modular reduction result.

In the above-mentioned process, based on the method provided in this embodiment of this specification, in a service processing process of homomorphic encryption-based privacy protection computation, a modulo operation is performed on the given value x for a related modulus (prime number). In a related multiplication operation, bit processing such as shifting and addition can be performed on another multiplier based on redundant bits in one multiplier, and only consecutive non-overlapping bits in the one multiplier are used as significant bits to implement the multiplication operation with the another multiplier by using a DSP unit. This greatly reduces online usage of hardware DSP units, improves modular reduction efficiency, and improves computation performance and service processing efficiency.

An embodiment of another aspect further provides a modular reduction operation apparatus, used to perform a modulo operation on a first modulus for a given value x in secure computation. The modular reduction operation apparatus can be disposed on any computer, device, or server that has a specific computing capability.

As shown in FIG. 3, the modular reduction operation apparatus 300 can include:
an acquisition unit 301, configured to obtain a modular reduction factor r₁ corresponding to the first modulus;
a detection unit 302, configured to detect at least one group of significant bits in the modular reduction factor r₁, where the significant bits are a plurality of consecutive bits that include non-overlapping bits, and the non-overlapping bits are adjacent different bits;
a first computation unit 303, configured to: compute a first product of each group of significant bits and the given value x; and
sequentially merge the first product with second products, and shift a merging result to the right by a first quantity of bits to obtain a first reference factor, where a single second product is determined by performing a corresponding bit operation on the given value x based on a corresponding single group of redundant bits, and the single group of redundant bits include a plurality of consecutive consistent bits;
a second computation unit 304, configured to subtract a third product of the first reference factor and the first modulus from the given value x, to obtain a second reference factor; and
a determining unit 305, configured to compare the second reference factor with the first modulus to determine a modular reduction result of the given value x for the first modulus based on a comparison result.

The modular reduction factor r₁ is obtained by taking the floor of a quotient of 2 to the power of 2k divided by the first modulus, and a predetermined value k meets a first condition: 2 to the power of k is greater than the first modulus.

According to an embodiment, the first computation unit 303 can compute the first product of each group of significant bits and the given value x by invoking a DSP unit.

In an embodiment, the first computation unit 303 can be configured to sequentially merge the first product with the second products in the following way:
separately determining bit positions of the first product and the second product relative to the modular reduction factor r₁; and
splicing and adding the first product and the second product based on the bit positions, to obtain a merging result.

In an embodiment, the first quantity is 2k.

It can be understood that:
when the single group of redundant bits are s consecutive 1s (s is a natural number greater than or equal to 2), the corresponding single second product is determined in the following way: shifting the given value x to the left by s+1 bits in a binary representation way and subtracting the given value x after padding vacated bits with 0s;
when the single group of redundant bits are s consecutive 0s, the corresponding single second product is determined by performing a bit operation: setting each bit to 0; and
when the single group of redundant bits include 1 of a d^{th} bit and several 0s, the corresponding single second product is determined by performing a bit operation: shifting the given value x to the left by d bits in the binary representation way.

According to a possible design, the second computation unit 304 can be configured to determine the third product in the following way:
detecting at least one group of significant bits in the first modulus, and computing a fourth product of each group of significant bits and the given value x; and
sequentially merging the fourth product with fifth products, and shifting a merging result to the right by the first quantity of bits in a binary representation way to obtain the third product, where a single fifth product is determined by performing a corresponding bit operation (for example, shifting or addition) on the first reference factor based on a corresponding single group of redundant bits of the first modulus.

According to some optional implementations, the determining unit 305 can be further configured to:
when the second reference factor is less than the first modulus, determine the second reference factor as the modular reduction result; or
when the second reference factor is greater than or equal to the first modulus, determine a difference between the second reference factor and the first modulus as the modular reduction result.

It is worthwhile to note that the apparatus 300 shown in FIG. 3 corresponds to the method described in FIG. 2, and corresponding descriptions in the method embodiment shown in FIG. 2 are also applicable to the apparatus 300. Details are omitted here for simplicity.

An embodiment of another aspect further provides a computer-readable storage medium. The computer-readable storage medium stores a computer program, and when the computer program is executed on a computer, the computer is enabled to perform the method described with reference to FIG. 2, etc.

An embodiment of still another aspect further provides a computing device, including a memory and a processor. The memory stores executable code, and when the processor executes the executable code, the method described with reference to FIG. 2, etc. is implemented.

A person skilled in the art should be aware that in the one or more examples, functions described in embodiments of this specification can be implemented by using hardware, software, firmware, or any combination thereof. When implemented by using software, these functions can be stored in a computer-readable medium or transmitted as one or more instructions or one or more pieces of code on a computer-readable medium.

The objectives, technical solutions, and beneficial effects of the technical concepts of this specification are further described in detail in the above-mentioned specific implementations. It should be understood that the above-mentioned descriptions are merely specific implementations of the technical concepts of this specification, but are not intended to limit the protection scope of the technical concepts of this specification. Any modification, equivalent replacement, improvement, etc. made based on the technical solutions of the embodiments of this specification shall fall within the protection scope of the technical concepts of this specification.

What is claimed is:

1. A modular reduction operation method, used to perform a modulo operation on a first modulus for a given value x in secure computation, wherein the method comprises:
obtaining a modular reduction factor r₁ corresponding to the first modulus;
detecting at least one group of significant bits in the modular reduction factor r₁, wherein the significant bits are a plurality of consecutive bits that comprise non-overlapping bits, and the non-overlapping bits are adjacent different bits;
computing a first product of each group of significant bits and the given value x;
sequentially merging the first product with second products, and shifting a merging result to the right by a first quantity of bits to obtain a first reference factor, wherein a single second product is determined by performing a corresponding bit operation on the given value x based on a corresponding single group of redundant bits, and the single group of redundant bits comprise a plurality of consecutive overlapping bits;
subtracting a third product of the first reference factor and the first modulus from the given value x, to obtain a second reference factor; and
comparing the second reference factor with the first modulus to determine a modular reduction result of the given value x for the first modulus based on a comparison result.

2. The method according to claim 1, wherein the modular reduction factor r₁ is obtained by taking the floor of a quotient of 2 to the power of 2k divided by the first modulus, and a predetermined value k meets a first condition: 2 to the power of k is greater than the first modulus.

3. The method according to claim 1, wherein the computing a first product of each group of significant bits and the given value x is implemented by invoking a DSP unit.

4. The method according to claim 1, wherein the sequentially merging the first product with second products comprises:
separately determining bit positions of the first product and the second product relative to the modular reduction factor r₁; and
splicing and adding the first product and the second product based on the bit positions, to obtain a merging result.

5. The method according to claim 2, wherein the first quantity is 2k.

6. The method according to claim 1, wherein
when the single group of redundant bits are s consecutive 1s, the corresponding single second product is determined by performing a bit operation: shifting the given value x to the left by s+1 bits in a binary representation way and subtracting the given value x after padding vacated bits with 0s;
when the single group of redundant bits are s consecutive 0s, the corresponding single second product is determined by performing a bit operation: setting each bit to 0; and
when the single group of redundant bits comprise 1 of a d^{th} bit and several 0s, the corresponding single second product is determined by performing a bit operation: shifting the given value x to the left by d bits in the binary representation way.

7. The method according to claim 1, wherein the third product is determined in the following way:
detecting at least one group of significant bits in the first modulus, and computing a fourth product of each group of significant bits and the given value x; and
sequentially merging the fourth product with fifth products, and shifting a merging result to the right by the first quantity of bits in a binary representation way to obtain the third product, wherein a single fifth product is determined by performing a corresponding bit operation on the first reference factor based on a corresponding single group of redundant bits of the first modulus.

8. The method according to claim 1, wherein the comparing the second reference factor with the first modulus to determine a modular reduction result of the given value x for the first modulus based on a comparison result comprises:
when the second reference factor is less than the first modulus, determining the second reference factor as the modular reduction result; or
when the second reference factor is greater than or equal to the first modulus, determining a difference between the second reference factor and the first modulus as the modular reduction result.

9-10. (canceled)

11. A computing device, comprising a memory and a processor, wherein the memory stores executable code, and when the processor executes the executable code, the computing device is caused to:
obtain a modular reduction factor r₁ corresponding to the first modulus;
detect at least one group of significant bits in the modular reduction factor r₁, wherein the significant bits are a plurality of consecutive bits that comprise non-overlapping bits, and the non-overlapping bits are adjacent different bits;
compute a first product of each group of significant bits and the given value x; and
sequentially merge the first product with second products, and shift a merging result to the right by a first quantity of bits to obtain a first reference factor, wherein a single second product is determined by performing a corresponding bit operation on the given value x based on a corresponding single group of redundant bits, and the single group of redundant bits comprise a plurality of consecutive overlapping bits;
subtract a third product of the first reference factor and the first modulus from the given value x, to obtain a second reference factor; and
compare the second reference factor with the first modulus to determine a modular reduction result of the given value x for the first modulus based on a comparison result.

12. The computing device according to claim 11, wherein the modular reduction factor r₁ is obtained by taking the floor of a quotient of 2 to the power of 2k divided by the first modulus, and a predetermined value k meets a first condition: 2 to the power of k is greater than the first modulus.

13. The computing device according to claim 11, wherein the computing device being caused to compute a first product of each group of significant bits and the given value x is implemented by invoking a DSP unit.

14. The computing device according to claim 11, wherein the computing device being caused to sequentially merge the first product with second products comprises being caused to:
separately determine bit positions of the first product and the second product relative to the modular reduction factor r₁; and
splice and add the first product and the second product based on the bit positions, to obtain a merging result.

15. The computing device according to claim 12, wherein the first quantity is 2k.

16. The computing device according to claim 11, wherein
when the single group of redundant bits are s consecutive 1s, the corresponding single second product is determined by performing a bit operation: shifting the given value x to the left by s+1 bits in a binary representation way and subtracting the given value x after padding vacated bits with 0s;
when the single group of redundant bits are s consecutive 0s, the corresponding single second product is determined by performing a bit operation: setting each bit to 0; and
when the single group of redundant bits comprise 1 of a d^{th} bit and several 0s, the corresponding single second product is determined by performing a bit operation: shifting the given value x to the left by d bits in the binary representation way.

17. The computing device according to claim 11, wherein the third product is determined in the following way:
detecting at least one group of significant bits in the first modulus, and computing a fourth product of each group of significant bits and the given value x; and
sequentially merging the fourth product with fifth products, and shifting a merging result to the right by the first quantity of bits in a binary representation way to obtain the third product, wherein a single fifth product is determined by performing a corresponding bit operation on the first reference factor based on a corresponding single group of redundant bits of the first modulus.

18. The computing device according to claim 11, wherein the computing device being caused to compare the second reference factor with the first modulus to determine a modular reduction result of the given value x for the first modulus based on a comparison result comprises being caused to:
when the second reference factor is less than the first modulus, determine the second reference factor as the modular reduction result; or
when the second reference factor is greater than or equal to the first modulus, determine a difference between the second reference factor and the first modulus as the modular reduction result.

19. A non-transitory computer-readable storage medium storing instructions, wherein the non-transitory computer-readable storage medium stores a computer program, which when executed by a processor causes the processor to:
obtain a modular reduction factor r₁ corresponding to the first modulus;
detect at least one group of significant bits in the modular reduction factor r₁, wherein the significant bits are a plurality of consecutive bits that comprise non-overlapping bits, and the non-overlapping bits are adjacent different bits;
compute a first product of each group of significant bits and the given value x; and
sequentially merge the first product with second products, and shift a merging result to the right by a first quantity of bits to obtain a first reference factor, wherein a single second product is determined by performing a corresponding bit operation on the given value x based on a corresponding single group of redundant bits, and the single group of redundant bits comprise a plurality of consecutive overlapping bits;
subtract a third product of the first reference factor and the first modulus from the given value x, to obtain a second reference factor; and
compare the second reference factor with the first modulus to determine a modular reduction result of the given value x for the first modulus based on a comparison result.

20. The non-transitory computer-readable storage medium according to claim 19, wherein the modular reduction factor r₁ is obtained by taking the floor of a quotient of 2 to the power of 2k divided by the first modulus, and a predetermined value k meets a first condition: 2 to the power of k is greater than the first modulus.

21. The non-transitory computer-readable storage medium according to claim 19, wherein the processor being caused to compute a first product of each group of significant bits and the given value x is implemented by invoking a DSP unit.

22. The non-transitory computer-readable storage medium according to claim 19, wherein the processor being caused to sequentially merge the first product with second products comprises being caused to:
separately determine bit positions of the first product and the second product relative to the modular reduction factor r₁; and
splice and add the first product and the second product based on the bit positions, to obtain a merging result.
